(19) United States
(12) Patent Application Publication
(10) Pub. No.: US 2023/0018924 A1
(43) Pub. Date: Jan. 19, 2023

(54) ABS RUBBER POWDER WITH LOW IMPURITY CONTENT, PREPARATION METHOD THEREFOR, AND ABS RESIN

(71) Applicant: WANHUA CHEMICAL GROUP CO., LTD., Yantai (CN)

(72) Inventors: Qiang HAN, Yantai (CN); Qinhua ZHANG, Yantai (CN); Ning MA, Yantai (CN); Yibing ZHAO, Yantai (CN); Shuangyi SUN, Yantai (CN); Bo LIU, Yantai (CN); Yifeng SUN, Yantai (CN)

(73) Assignee: WANHUA CHEMICAL GROUP CO., LTD., Yantai (CN)

(21) Appl. No.: 17/784,879

(22) PCT Filed: Dec. 23, 2019
(86) PCT No.: PCT/CN2019/127650

§ 371 Date: Jun. 13, 2022

(51) Int. Cl. C08F 279/04; C08F 2/26; C08F 2/38; C08F 2/02; C08F 6/16; C08F 6/22; C08J 3/16

(52) U.S. Cl. CPC C08F 279/04; C08F 2/26; C08F 2/38; C08F 2/02; C08F 6/16; C08F 6/22; C08J 3/16; C08J 2355/02

(57) ABSTRACT

Disclosed in the present invention are ABS rubber powder with a low impurity content, a preparation method therefor, and an ABS resin. The ABS rubber powder is treated by using the following steps: washing the ABS rubber powder with a washing solution I, and monitoring the content of soluble organic carbon in the ABS rubber powder until the content of soluble organic carbon in the ABS rubber powder is less than or equal to 9000 ppm, so as to obtain the ABS rubber powder with the low impurity content. In the present invention, by controlling the content of soluble organic carbon or the contents of soluble organic carbon and iron ions in the ABS powder, the ABS resin with a low yellow index of less than or equal to 18 is obtained.

### TECHNICAL FIELD

The present disclosure belongs to the field of engineering plastic ABS resin production technology and, in particular, relates to a preparation method for an ABS resin with a low yellowness index.

### BACKGROUND

ABS resin is one of the five synthetic resins and is obtained by ternary polymerization of butadiene, styrene and acrylonitrile. It is widely used in machinery, automobiles, electronics & electrical appliances, instruments and apparatus, textiles and buildings and is a kind of thermoplastic engineering plastic with wide application.

At present, the continuous bulk method and the emulsion grafting-bulk SAN blending method are two widely used methods to prepare the ABS resin. At present, the emulsion grafting-bulk SAN blending method has the advantages of advanced technology, wide product range, large output per unit and less pollution and has become the mainstream method for producing the ABS resin.

The emulsion grafting-bulk SAN blending method includes the following steps: firstly butadiene is polymerized to produce polybutadiene latex (PBL), then polybutadiene latex, styrene and acrylonitrile are subjected to graft polymerization, then coagulated and dried to obtain ABS rubber powder, and the ABS rubber powder and the SAN resin produced by the bulk method are blended and pelletized to obtain the ABS resin.

Some application fields, such as automobiles, household appliances, etc., have higher appearance requirements for the ABS resin, and the yellowness index of the ABS resin is required to be lower. Patent CN109608782A discloses a preparation method of yellowing-resistant ABS resin, where a functional monomer with an epoxy group is introduced into the shell layer of the grafted powder, and by utilizing an epoxy group and a cyano group, the cyclization reaction between the acrylonitrile groups in the ABS resin in the heating process is relieved, thereby reducing the yellowness index of the ABS resin. Although this method can reduce the yellowness index of the ABS resin in the processing process, the yellowness index of the ABS resin itself is not improved, and the reaction process between the introduced functional monomer with an epoxy group and acrylonitrile is uncontrollable, which causes many side reactions.

Patent CN201711360467X discloses a high-performance long-acting anti-yellowing ABS material and a preparation method thereof, which reduces the yellowness index of ABS by adding an anti-yellowing agent to an ABS resin. Patent CN103819802B discloses a high-density polyethylene compound additive and a preparation method thereof. In the method, the compound antioxidant is prepared by adding an antioxidant 330, an antioxidant 168 and an antioxidant 1076, and through the synergistic effect between the compound antioxidant and other additives, the oxidation induction period is prolonged, thereby reducing the yellow index. The above two patents improve the yellowness index of products by adding additives, which increases the cost of products.

Compared with the continuous bulk method, the color of the ABS resin prepared by the emulsion grafting-bulk SAN blending method is yellowish, which is caused by the use of a large number of additives in the unit for producing ABS powder by emulsion grafting when the emulsion grafting-bulk SAN blending method is adopted.

Therefore, it is urgent to develop a method for producing an ABS resin with a low yellowness index by the emulsion grafting-bulk SAN blending process.

### SUMMARY

In view of the above, the present disclosure provides an ABS rubber powder with a low impurity content, a preparation method therefor, and an ABS resin prepared from the ABS rubber powder. By controlling the content of soluble organic carbon or the contents of soluble organic carbon and iron ions in the ABS powder, an ABS resin with a low yellowness index is obtained.

To achieve the objects of the present disclosure, the present disclosure adopts the following technical solutions:

A first aspect of the present disclosure provides a preparation method for ABS rubber powder with a low impurity content, where the ABS rubber powder is treated by using the following steps:

washing the ABS rubber powder with a washing solution I, and monitoring the content of soluble organic carbon in the ABS rubber powder until the content of soluble organic carbon in the ABS rubber powder is less than or equal to 9000 ppm, for example, the content of soluble organic carbon is 8600 ppm, 4500 ppm, 4377 ppm or 3700 ppm, so as to obtain the ABS rubber powder with the low impurity content.

In some preferred embodiments, the ABS rubber powder is treated by using the following steps:

washing the ABS rubber powder with a washing solution I, and monitoring the content of soluble organic carbon in the ABS rubber powder until the content of soluble organic carbon in the ABS rubber powder is less than or equal to 5000 ppm, for example, the content of soluble organic carbon is 4500 ppm, 4377 ppm or 3700 ppm, so as to obtain the ABS rubber powder with the low impurity content.

In some specific embodiments, after the ABS rubber powder is washed until the content M of soluble organic carbon in the ABS rubber powder is less than or equal to 9000 ppm, for example, the content of soluble organic carbon is 8600 ppm, 4500 ppm, 4377 ppm or 3700 ppm, the washed ABS rubber powder is filtered out and dried at 40° C.-80° C. until the content of water in the ABS rubber powder is about 1%, so as to obtain the ABS rubber powder with the low impurity content.

In the above-mentioned preparation method, the content of soluble organic carbon in the washed ABS rubber powder is controlled to be less than or equal to 9000 ppm, for example, 8600 ppm, 4500 ppm, 4377 ppm or 3700 ppm, and preferably, the content of soluble organic carbon in the washed ABS rubber powder is controlled to be less than or equal to 5000 ppm, for example, 4500 ppm, 4377 ppm or 3700 ppm. In the above preparation method, through the above-mentioned treatment, the content range of soluble organic carbon in polymer rubber powder is controlled so that the lower the mass concentration of the soluble fraction of the residual total organic carbon (TOC) in the system, the lower the impurity contributed to the polymer rubber powder and the lower the yellowness index of the resin prepared from the polymer rubber powder. The “soluble organic carbon” mentioned in the present disclosure refers to the organic carbon part in ABS rubber powder which can be dissolved into water or an alkaline solution.

In the present disclosure, the content unit “ppm” of the soluble organic carbon in the polymer rubber powder is based on the mass of the ABS rubber powder.

During the research, the researchers of the present disclosure found that the soluble organic carbon is mostly introduced in the polymerization process of ABS rubber powder, due to the residual unreacted acrylonitrile monomer in the polymerization process, the emulsifier and the oligomer produced in the reaction process, where the acrylonitrile monomer and the oligomer will undergo a crosslinking reaction when exposed to high temperature, and longer acrylonitrile segments will be conjugated due to cyclization, and conjugated double bonds can absorb the blue spectral band in visible light and make the product earthy yellow. In addition, the double bonds in the emulsifier are easily oxidized by oxygen and darken the color, which leads to the increase of the yellowness index of the final ABS resin product. In the preparation process of the present disclosure, the ABS rubber powder is washed with the washing solution I, and the content of the soluble organic carbon in the ABS rubber powder is monitored until the content of the soluble organic carbon is reduced to the above-mentioned range, thereby effectively reducing the content of the organic matter causing yellowing in the ABS rubber powder.

Meanwhile, the researchers of the present disclosure found that iron ions are introduced in the preparation process of the ABS rubber powder in the following conditions which are not limited thereto. For example, in the process of the emulsion polymerization, when ferrous sulfate is used as the reducing component in the initiator, iron ions enter the reaction system. For example, when the polybutadiene agglomerated latex is prepared by acetic acid agglomeration and/or when the grafted latex is agglomerated using sulfuric acid or other acidic substances as the coagulant, the corrosion of acid on the metal container causes iron in the metal container to enter the reaction system in the form of acid salts of trivalent iron. After the ferrous ions in the system are oxidized, ferric sulfate soluble in water and ferric hydroxide insoluble in water are formed, and the unique yellow color of ferric ions leads to the increase of the yellowness index of the product. In addition, ferrous ions, as variable valence metal ions, can catalyze the residual double bonds in the ABS rubber powder at high temperatures, which intensifies the formation of by-products containing conjugated groups and leads to the yellowing of the product. In the present disclosure, the iron ions mentioned herein include divalent ferrous ions and/or trivalent iron ions.

In some specific embodiments, the ABS rubber powder with the low impurity content is washed with a washing solution II, and the content of iron ions in the ABS rubber powder is monitored until the content of iron ions in the ABS rubber powder with the low impurity content is less than or equal to 50 ppm, for example, 46 ppm, 17.3 ppm, 17 ppm, 9 ppm, 8.2 ppm, 8 ppm or 7 ppm.

In some specific embodiments, after the ABS rubber powder is washed until the content of iron ions in the ABS rubber powder is less than or equal to 50 ppm, the washed ABS rubber powder is filtered out and dried at 40° C.-80° C. until the content of water in the ABS rubber powder is about 1%, so as to obtain the ABS rubber powder with the low impurity content.

In some other specific embodiments, the obtained ABS rubber powder with the low impurity content described above is washed with the washing solution II until the content of iron ions in the ABS rubber powder with the low impurity content is less than or equal to 10 ppm, for example, 9 ppm, 8.2 ppm, 8 ppm or 7 ppm.

In the present disclosure, the washing solution I is selected from water or an alkaline solution, and the alkaline solution is an aqueous solution with a mass percentage of 0.1%-3%. In some preferred embodiments, the alkaline solution is selected from an aqueous ammonia solution, an aqueous potassium hydroxide solution or an aqueous sodium hydroxide solution.

The washing solution II is selected from water or an acidic solution. When the washing solution I is selected from water, the washing solution II is selected from water or an acid solution; and when the washing solution I is selected from an alkaline solution, the washing solution II is selected from an acidic solution. The acid solution is preferably selected from an aqueous acetic acid solution, an aqueous hydrochloric acid solution or an aqueous sulfuric acid solution.

The ABS rubber powder in the present disclosure can adopt commercial ABS rubber powder products, for example, ERMA151B, HR-150F, HR-181, HR-183 and HR-85 from KUMHO, Korea; BP-828 from FORMOSA CHEMICALS INDUSTRIES (Ningbo); 338 and 360 from SABIC INNOVATIVE PLASTICS (USA); S-3811 from SAMYANG, Japan; WD-132 and WD-133 from Shandong WANDA; and DP60 from SHINHO (Changzhou) PETROCHEMICAL. The polymerization method of the ABS rubber powder in the present disclosure may also be the existing polymerization method and is not limited to a specific polymerization mode. For example, the ABS rubber powder before the treatment is prepared by the method including the following steps:

(1) subjecting butadiene and an optional second monomer to emulsion polymerization to obtain polybutadiene latex;

(2) subjecting the polybutadiene latex, styrene, acrylonitrile and an optional third monomer to emulsion polymerization to obtain grafted ABS latex;

(3) subjecting the grafted ABS latex to a coagulation-curing treatment, and then filtering and drying same to obtain the ABS rubber powder;

preferably, the coagulation-curing treatment in step (3) is: adding a coagulant to the grafted ABS latex for coagulation, and curing the grafted ABS latex for 0.5-2 hours.

In some specific embodiments, in step (1) of the present disclosure, the emulsion polymerization includes the following steps: mixing the butadiene, the optional second monomer, an emulsifier, an optional buffer, a chain transfer agent, an initiator and water, and carrying out the emulsion polymerization at 60° C.-90° C. to obtain the polybutadiene latex, where the emulsion polymerization is carried out until the particle size of the polybutadiene latex is 200-400 nm;

in step (1), in parts by weight, the butadiene is 90-100 parts, the second monomer is 0-10 parts, the emulsifier is 1-5 parts, the buffer is 0-1 part, the chain transfer agent is 0.2-0.7 part, the initiator is 0.1-0.5 part, and the water is 100-150 parts;

preferably, in step (1), in parts by weight, the butadiene is 93-98 parts, the second monomer is 2-7 parts, the emulsifier is 2-4 parts, the buffer is 0.3-0.7 part, the chain transfer agent is 0.3-0.6 part, the initiator is 0.2-0.4 part, and the water is 110-140 parts.

In some specific embodiments, in step (2) of the present disclosure, the emulsion polymerization includes the following steps: mixing the polybutadiene latex, the styrene, the acrylonitrile, the optional third monomer, an emulsifier, an initiator, a chain transfer agent, an optional buffer and optional water, carrying out the emulsion polymerization at 60° C.-90° C., carrying out depressurization and steam desorption when the conversion rate of butadiene is greater than or equal to 95%, and removing residual low-boiling substances, so as to obtain polybutadiene latex when the residual monomer of butadiene is less than or equal to 1000 ppm;

in step (2), in parts by weight, the polybutadiene latex is 55-70 parts, the styrene is 20-35 parts, the acrylonitrile is 5-20 parts, the third monomer is 0-5 parts, the emulsifier is 0.2-1 part, the initiator is 0.1-0.5 part, the chain transfer agent is 0.1-1 part, the buffer is 0-0.01 part, and the water is 0-20 parts;

preferably, in step (2), in parts by weight, the polybutadiene latex is 60-65 parts, the styrene is 25-30 parts, the acrylonitrile is 10-15 parts, the third monomer is 1-3 parts, the emulsifier is 0.4-0.8 part, the initiator is 0.2-0.4 part, the chain transfer agent is 0.3-0.7 part, the buffer is 0.006-0.008 part, and the water is 5-15 parts.

In some specific embodiments, in step (1) of the present disclosure, the second monomer is selected from one or more of styrene, acrylonitrile or methyl methacrylate;

in step (2) of the present disclosure, the third monomer is selected from butadiene and/or methyl methacrylate.

In some specific embodiments, in steps (1) and (2) of the present disclosure, the emulsifier is selected from an anionic emulsifier and preferably is selected from one or more of potassium oleate, sodium dodecyl sulfate or potassium disproportionated rosin acid;

the buffer is selected from one or more of sodium carbonate, sodium bicarbonate, potassium carbonate, potassium bicarbonate, sodium hydroxide, potassium hydroxide, disodium ethylenediaminetetraacetic acid, tetrasodium ethylenediaminetetraacetic acid or sodium pyrophosphate;

the chain transfer agent is selected from one or more of t-dodecyl mercaptan, n-dodecyl mercaptan, a-methylstyrene dimer or isooctyl 3-mercaptopropionate;

in step (1) of the present disclosure, the initiator is selected from one or more of potassium persulfate, sodium persulfate or ammonium persulfate;

in step (2) of the present disclosure, the initiator is selected from an oxidation-reduction initiator, where the oxidant component in the oxidation-reduction initiator is selected from one or more of potassium persulfate, sodium persulfate, ammonium persulfate, tert-butyl hydroperoxide, tert-amyl hydroperoxide or cumene hydroperoxide; and the reductant component in the oxidation-reduction initiator is selected from one or more of sodium formaldehyde sulfoxylate, sodium dithionite, ascorbic acid, erythorbic acid, sodium bisulfite, sodium metabisulfite, lactose, glucose, sorbose, fructose, maltose or ferrous sulfate. In some specific embodiments, the mass ratio of the oxidant component to the reductant component in the initiator is 1-30:1, for example, 10:1, 20:1 or 25:1.

In some specific embodiments, in step (2) of the present disclosure, the coagulant is selected from one or more of calcium chloride, magnesium sulfate, sulfuric acid or acetic acid;

the coagulant is preferably an aqueous coagulant solution with a mass percentage concentration of 2%-10%, and the addition amount of the coagulant is 4-6 wt % of the solid content (mass of the solid) in the grafted ABS latex.

A second aspect of the present disclosure provides an ABS resin, which is prepared by blending the ABS rubber powder prepared by the above-mentioned preparation method and a SAN resin, and the yellowness index of the ABS resin is less than or equal to 18.

As is well known to those skilled in the art, the SAN resin is a copolymer of styrene and acrylonitrile and is an engineering plastic with high mechanical strength; the ABS resin refers to the acrylonitrile-butadiene-styrene copolymer and is generally prepared by carrying out mechanical blending, melt pelletizing and drying on the SAN resin and the ABS rubber powder; and the ABS rubber powder belongs to the raw material for preparing the ABS resin.

In some specific embodiments, in parts by weight, the raw material for mechanical blending includes 20-40 parts of the ABS rubber powder, 60-80 parts of the SAN resin, 0.1-0.8 part of an antioxidant and a lubricant; where the antioxidant is preferably selected from one or more of 2,2′-methylenebis(4-methyl-6-tert-butylphenol), β-(4-hydroxy-3,5-di-tert-butylphenyl)propionic acid n-octadecyl alcohol ester, tetra-[β-(3,5-di-tert-butyl-4-hydroxyphenyl)propionic acid]-pentaerythritol ester, tris(2,4-di-tert-butylphenyl)phosphite or dilauryl thiodipropionate; for example, the antioxidant may be commercially available B900 from BASF, Germany; and the lubricant may be selected from magnesium stearate and N,N-ethylene bis stearamide.

As is well known to those skilled in the art, the yellowness index of the SAN resin is very low, has little effect on the yellowness index of the ABS resins, and thus may be neglected. The SAN resin is commercially available and is, for example, selected from one of SAN 230G, 250G, 260G and 280G from ELIX POLYMERS; SAN 327, 325 and 350 from PetroChina Daqing Petrochemical; SAN 168 from Zhenjiang GPPC Chemical Co., Ltd.; or PN118L150 from CHIMEI.

The above-mentioned technical solutions have the following technical effects:

In the preparation method for ABS rubber powder with a low impurity content provided by the present disclosure, the content of soluble organic carbon in the ABS rubber powder is controlled to be less than or equal to 9000 ppm on the basis of the existing art, thereby reducing the content of impurities in the ABS rubber powder; and preferably, the content of iron ions in the ABS rubber powder is also controlled to be less than or equal to 50 ppm, further reducing the content of impurities in the rubber powder.

In the present disclosure, the obtained ABS rubber powder is used for preparing the ABS resin so that the yellowness index of the obtained resin is less than or equal to 18, broadening the application field of the ABS resin.

### DETAILED DESCRIPTION

The technical solutions and effects thereof of the present disclosure will be further described hereinafter through the specific examples. It is to be understood that the examples described below are intended to illustrate the present disclosure but are not construed to limit the scope thereof. The simple modifications made to the present disclosure in accordance with the concept of the present disclosure are within the scope of the present disclosure. The test manners used in the examples of the present disclosure are as follows:

(1) Yellowness index: standard ASTM D6166, using BYK Gardner instrument, USA;

(2) Content of soluble organic carbon:

10 g of ABS rubber powder was dissolved in 100 g of KOH aqueous solution with a mass percentage of 1%, the insoluble matter was filtered out, and the content of soluble organic carbon in the remaining filtrate was detected; and the content of soluble organic carbon in the filtrate was detected in accordance with standard HJ 501-2009 using multi N/C® 3000 series TOC analyzer from JENA, Germany.

Content of soluble organic carbon in ABS rubber powder=10*content of soluble organic carbon in the filtrate;

(3) Content of metal ions: standard SL 394.1-2007, using Agilent 720 ICP-OES spectrometer, USA;

(4) Measurement of latex particle size: the prepared sample was diluted with deionized water until the mass concentration was 0.05% and then tested using a Malvern-Nano-ZS90 particle size analyzer.

In the following examples, the information of raw materials used is as follows:

SAN resin: PN118L150, ZHENJIANG CHIMEI;

antioxidant: B900, BASF, Germany; and
618, PWF Chemical (Shanghai) Co., Ltd.;

ABS rubber powder 1: DP60, SHINHO (Changzhou) PETROCHEMICAL;

ABS rubber powder 2: self-made using the following preparation method.

In the examples of the present disclosure, other raw materials and other reagents used herein are conventional reagents in the art, and the purity specification is analytical grade.

In the preparation examples of the ABS rubber powder, each part is part by weight.

(1) Preparation of polybutadiene latex: according to the weight parts of each component, 1.5 parts of potassium oleate, 1.5 parts of potassium disproportionated rosin acid, 95 parts of butadiene, 5 parts of styrene, 0.05 part of potassium carbonate, 0.05 part of potassium hydroxide, 0.45 part of t-dodecyl mercaptan (TDM), 0.3 part of potassium persulfate and 130 parts of deionized water were added to a reaction kettle, heated up to 70° C., and subjected to polymerization reaction, depressurization and steam desorption were carried out when the conversion rate of butadiene was greater than or equal to 95%, and residual low-boiling substances were removed, so as to obtain polybutadiene latex when the residual monomer of butadiene was less than or equal to 1000 ppm.

An acetic acid solution with a mass concentration of 5% was slowly added to the polybutadiene latex and stirred, a KOH solution with a mass concentration of 5% was slowly added when the particle size reached 300 nm, and pH was adjusted to 10, so as to obtain the agglomerated polybutadiene latex, where the particle size of the polybutadiene latex was 300 nm.

(2) According to the weight parts of each component, 63 parts of the agglomerated polybutadiene latex were added to a grafting kettle and heated up to 80° C., 0.25 part of cumene hydrogen peroxide, 0.01 part of lactose, 0.00015 part of ferrous sulfate, 28 parts of styrene, 12 parts of acrylonitrile, 0.45 parts of t-dodecyl mercaptan (TDM), 5 parts of butadiene, 0.007 part of sodium pyrophosphate, 0.6 part of potassium oleate and 10 parts of deionized water were added for polymerization reaction, so as to obtain the grafted ABS latex when the conversion rate of acrylonitrile was 97%.

(3) 4 parts of 10% aqueous magnesium sulfate solution and 1 part of 5% aqueous acetic acid solution were added to 100 parts of the grafted ABS latex, aged for 2 hours, filtered and dried at 80° C. until the content of water content was 1%, so as to obtain the ABS rubber powder 1.

The contents of soluble organic carbon and iron ions in equal weight parts of the ABS rubber powder 1 prepared above were detected. The content of soluble organic carbon was 12000 ppm, and the content of iron ions was 94.2 ppm.

The contents of soluble organic carbon and iron ions in equal weight parts of the commercially available DP60 ABS powder were detected. The content of soluble organic carbon was 10000 ppm, and the content of iron ions was 17.8 ppm.

### Example 1

1 kg of ABS rubber powder 1 prepared above was washed with 5 kg of an aqueous sodium hydroxide solution with a percentage by mass of 0.5%, and the contents of soluble organic carbon and iron ions in the ABS rubber powder 1 were monitored to be 8600 ppm and 94 ppm respectively. The ABS rubber powder 1 was filtered and dried until the content of water was 1%, so as to obtain the ABS rubber powder 1 with a low impurity content.

### Example 2

1 kg of the ABS rubber powder 1 with a low impurity content prepared in Example 1 was washed with 1 kg of an aqueous sodium hydroxide solution with a percentage by mass of 1%, and the contents of soluble organic carbon and iron ions in the ABS rubber powder 1 were monitored to be 4377 ppm and 94 ppm respectively. The ABS rubber powder 1 was filtered and dried until the content of water was 1%, so as to obtain the ABS rubber powder 2 with a low impurity content.

### Example 3

1 kg of ABS rubber powder 1 prepared above was washed with 1 kg of deionized water, and the contents of soluble organic carbon and iron ions in the ABS rubber powder 1 were monitored to be 8900 ppm and 83 ppm respectively. The ABS rubber powder 1 was filtered and dried until the content of water was 1%, so as to obtain the ABS rubber powder 3 with a low impurity content.

### Example 4

1 kg of the ABS rubber powder 3 with a low impurity content prepared in Example 3 was washed with 3 kg of deionized water, and the contents of soluble organic carbon and iron ions in the ABS rubber powder were monitored to be 4500 ppm and 57 ppm respectively. The ABS rubber powder was filtered and dried until the content of water was 1%, so as to obtain the ABS rubber powder 4 with a low impurity content.

### Example 5

1 kg of the ABS rubber powder 1 with a low impurity content prepared in Example 1 was washed with 1 kg of an aqueous acetic acid solution with a percentage by mass of 1%, and the content of iron ions in the ABS rubber powder was monitored to be 46 ppm. The ABS rubber powder was filtered and dried until the content of water was 1%, so as to obtain the ABS rubber powder 1-1 with a low impurity content.

1 kg of the ABS rubber powder 1-1 with a low impurity content was washed with 2 kg of an aqueous acetic acid solution with a percentage by mass of 3%, and the content of iron ions in the ABS rubber powder was monitored to be 8 ppm. The ABS rubber powder was filtered and dried until the content of water was 1%, so as to obtain the ABS rubber powder 1-2 with a low impurity content.

### Example 6

1 kg of the ABS rubber powder 2 with a low impurity content prepared in Example 2 was washed with 1.5 kg of an aqueous acetic acid solution with a percentage by mass of 2%, and the content of iron ions in the ABS rubber powder was monitored to be 44 ppm. The ABS rubber powder was filtered and dried until the content of water was 1%, so as to obtain the ABS rubber powder 2-1 with a low impurity content.

1 kg of the ABS rubber powder 2-1 with a low impurity content was washed with 2 kg of an aqueous acetic acid solution with a percentage by mass of 3%, and the content of iron ions in the ABS rubber powder was monitored to be 8.2 ppm. The ABS rubber powder was filtered and dried until the content of water was 1%, so as to obtain the ABS rubber powder 2-2 with a low impurity content.

### Example 7

1 kg of the ABS rubber powder 3 with a low impurity content prepared in Example 3 was washed with 3 kg of water, and the content of iron ions in the ABS rubber powder was monitored to be 47 ppm. The ABS rubber powder was filtered and dried until the content of water was 1%, so as to obtain the ABS rubber powder 3-1 with a low impurity content.

1 kg of the ABS rubber powder 3-1 with a low impurity content was washed with 7 kg of water, and the content of iron ions in the ABS rubber powder was monitored to be 9 ppm. The ABS rubber powder was filtered and dried until the content of water was 1%, so as to obtain the ABS rubber powder 3-2 with a low impurity content.

### Example 8

1 kg of the ABS rubber powder 4 with a low impurity content prepared in Example 4 was washed with 1 kg of water, and the content of iron ions in the ABS rubber powder was monitored to be 46 ppm. The ABS rubber powder was filtered and dried until the content of water was 1%, so as to obtain the ABS rubber powder 4-1 with a low impurity content.

1 kg of the ABS rubber powder 4-1 with a low impurity content was washed with 7 kg of water, and the content of iron ions in the ABS rubber powder was monitored to be 8 ppm. The

ABS rubber powder was filtered and dried until the content of water was 1%, so as to obtain the ABS rubber powder 4-2 with a low impurity content.

### Example 9

1 kg of commercially available DP60 ABS powder prepared above was washed with 0.5 kg of an aqueous sodium hydroxide solution with a percentage by mass of 0.5%, and the contents of soluble organic carbon and iron ions in the DP60 ABS powder were monitored to be 7300 ppm and 17.3 ppm respectively. The DP60 ABS powder was filtered and dried until the content of water was 1%, so as to obtain the ABS rubber powder 5 with a low impurity content.

The ABS rubber powder 5 with a low impurity content was washed with 1 kg of an aqueous sodium hydroxide solution with a percentage by mass of 0.5%, and the contents of soluble organic carbon and iron ions in the ABS rubber powder 5 were monitored to be 3700 ppm and 17 ppm respectively. The ABS rubber powder 5 was filtered and dried until the content of water was 1%, so as to obtain the ABS rubber powder 6 with a low impurity content.

### Example 10

1 kg of the ABS rubber powder 5 with a low impurity content prepared in Example 9 was washed with 2 kg of an aqueous acetic acid solution with a percentage by mass of 3%, and the content of iron ions in the ABS rubber powder was monitored to be 7 ppm. The ABS rubber powder was filtered and dried until the content of water was 1%, so as to obtain the ABS rubber powder 5-1 with a low impurity content.

### Example 11

1 kg of the ABS rubber powder 6 with a low impurity content prepared in Example 9 was washed with 2 kg of an aqueous acetic acid solution with a percentage by mass of 3%, and the content of iron ions in the ABS rubber powder was monitored to be 7 ppm. The ABS rubber powder was filtered and dried until the content of water was 1%, so as to obtain the ABS rubber powder 6-1 with a low impurity content.

### Comparative Example 1

The ABS rubber powder 1 prepared above.

### Comparative Example 2

The commercially available DP60 ABS powder.

The ABS rubber powder obtained in Examples 1 to 11 and Comparative Examples 1 to 2 was respectively mixed with a SAN resin to prepare an ABS resin specifically using the following method.

24 parts by weight of ABS rubber powder, 76 parts by weight of PN118L150 SAN resin, 0.1 part by weight of antioxidant B900, 0.2 part by weight of magnesium stearate and 2 parts by weight of N,N-ethylene bis stearamide were kneaded in a high-speed kneader for 5 minutes, and then the mixed material was subjected to melt pelletizing and blending in a twin-screw extruder and pelletized to obtain the following ABS resins respectively. The ABS resins obtained above were dried in an oven at 80° C. for 2 hours, and the yellowness index was tested. The test results are shown in Table 1.

TABLE 1

| Rubber powder | Resin | Yellowness index |
|---|---|---|
| ABS rubber powder 1 with a low impurity content | ABS resin 1 | 17.9 |
| ABS rubber powder 2 with a low impurity content | ABS resin 2 | 15.1 |
| ABS rubber powder 3 with a low impurity content | ABS resin 3 | 16.3 |
| ABS rubber powder 4 with a low impurity content | ABS resin 4 | 12 |
| ABS rubber powder 1-1 with a low impurity content | ABS resin 1-1 | 15.4 |
| ABS rubber powder 1-2 with a low impurity content | ABS resin 1-2 | 11.3 |
| ABS rubber powder 2-1 with a low impurity content | ABS resin 2-1 | 11.7 |
| ABS rubber powder 2-2 with a low impurity content | ABS resin 2-2 | 8.2 |
| ABS rubber powder 3-1 with a low impurity content | ABS resin 3-1 | 11.2 |
| ABS rubber powder 3-2 with a low impurity content | ABS resin 3-2 | 6.1 |
| ABS rubber powder 4-1 with a low impurity content | ABS resin 4-1 | 10.9 |
| ABS rubber powder 4-2 with a low impurity content | ABS resin 4-2 | 5.7 |
| ABS rubber powder 5 with a low impurity content | ABS resin 5 | 14.8 |
| ABS rubber powder 6 with a low impurity content | ABS resin 6 | 10.3 |
| ABS rubber powder 5-1 with a low impurity content | ABS resin 5-1 | 12.4 |
| ABS rubber powder 6-1 with a low impurity content | ABS resin 6-1 | 8.1 |
| ABS rubber powder 1 | ABS resin 8 | 29.2 |
| DP60 ABS rubber powder | ABS resin 9 | 27.7 |

1. A preparation method for ABS rubber powder with a low impurity content, wherein the ABS rubber powder is treated by using the following steps:
washing the ABS rubber powder with a washing solution I, and monitoring the content of soluble organic carbon in the ABS rubber powder until the content of soluble organic carbon in the ABS rubber powder is less than or equal to 9000 ppm, so as to obtain the ABS rubber powder with the low impurity content.

2. The preparation method according to claim 1, wherein the ABS rubber powder is treated by using the following steps:
washing the ABS rubber powder with a washing solution I, and monitoring the content of soluble organic carbon in the ABS rubber powder until the content of soluble organic carbon in the ABS rubber powder is less than or equal to 5000 ppm, so as to obtain the ABS rubber powder with the low impurity content.

3. The preparation method according to claim 1, wherein the treatment further comprises the following steps: washing the ABS rubber powder with the low impurity content with a washing solution II, and monitoring the content of iron ions in the ABS rubber powder until the content of iron ions in the ABS rubber powder with the low impurity content is less than or equal to 50 ppm;
preferably, the ABS rubber powder with the low impurity content is washed with the washing solution II until the content of iron ions in the ABS rubber powder with the low impurity content is less than or equal to 10 ppm.

4. The preparation method according to claim 3, wherein the washing solution I is selected from water or an alkaline solution, and the alkaline solution is an aqueous solution with a mass percentage of 0.1%-3%;
the alkaline solution is preferably selected from an aqueous ammonia solution, an aqueous potassium hydroxide solution or an aqueous sodium hydroxide solution.

5. The preparation method according to claim 4, wherein the washing solution II is selected from water or an acidic solution, and the acidic solution is an aqueous solution with a mass percentage of 0.1%-3%;
when the washing solution I is selected from water, the washing solution II is selected from water or an acid solution; and when the washing solution I is selected from an alkaline solution, the washing solution II is selected from an acidic solution;
the acid solution is preferably selected from an aqueous acetic acid solution, an aqueous hydrochloric acid solution or an aqueous sulfuric acid solution.

6. The preparation method according to claim 1, wherein the ABS rubber powder before the treatment is prepared by a method comprising the following steps:
(1) subjecting butadiene and an optional second monomer to emulsion polymerization to obtain polybutadiene latex;
(2) subjecting the polybutadiene latex, styrene, acrylonitrile and an optional third monomer to emulsion polymerization to obtain grafted ABS latex;
(3) subjecting the grafted ABS latex to a coagulation-curing treatment, and then filtering and drying same to obtain the ABS rubber powder;
preferably, the coagulation-curing treatment in step (3) is: adding a coagulant to the grafted ABS latex for coagulation, and curing the grafted ABS latex for 0.5-2 hours.

7. The preparation method according to claim 6, wherein in step (1), the emulsion polymerization comprises the following steps: mixing the butadiene, the optional second monomer, an emulsifier, an optional buffer, a chain transfer agent, an initiator and water, and carrying out the emulsion polymerization at 60° C.-90° C. to obtain the polybutadiene latex, wherein the particle size of the polybutadiene latex is preferably 200-400 nm;
in step (1), in parts by weight, the butadiene is 90-100 parts, the second monomer is 0-10 parts, the emulsifier is 1-5 parts, the buffer is 0-1 part, the chain transfer agent is 0.2-0.7 part, the initiator is 0.1-0.5 part, and the water is 100-150 parts;
preferably, in step (1), in parts by weight, the butadiene is 93-98 parts, the second monomer is 2-7 parts, the emulsifier is 2-4 parts, the buffer is 0.3-0.7 part, the chain transfer agent is 0.3-0.6 part, the initiator is 0.2-0.4 part, and the water is 110-140 parts.

8. The preparation method according to claim 7, wherein in step (2), the emulsion polymerization comprises the following steps: mixing the polybutadiene latex, the styrene, the acrylonitrile, the optional third monomer, an emulsifier, an initiator, a chain transfer agent, an optional buffer and optional water, and carrying out the emulsion polymerization at 60° C.-90° C.;
in step (2), in parts by weight, the polybutadiene latex is 55-70 parts, the styrene is 20-35 parts, the acrylonitrile is 5-20 parts, the third monomer is 0-5 parts, the emulsifier is 0.2-1 part, the initiator is 0.1-0.5 part, the chain transfer agent is 0.1-1 part, the buffer is 0-0.01 part, and the water is 0-20 parts;
preferably, in step (2), in parts by weight, the polybutadiene latex is 60-65 parts, the styrene is 25-30 parts, the acrylonitrile is 10-15 parts, the third monomer is 1-3 parts, the emulsifier is 0.4-0.8 part, the initiator is 0.2-0.4 part, the chain transfer agent is 0.3-0.7 part, the buffer is 0.006-0.008 part, and the water is 5-15 parts.

9. The preparation method according to claim 6, wherein in step (1), the second monomer is selected from one or more of styrene, acrylonitrile or methyl methacrylate;
in step (2), the third monomer is selected from butadiene and/or methyl methacrylate.

10. The preparation method according to claim 9, wherein in steps (1) and (2), the emulsifier is selected from an anionic emulsifier and preferably is selected from one or more of potassium oleate, sodium dodecyl sulfate or potassium disproportionated rosin acid;
the buffer is selected from one or more of sodium carbonate, sodium bicarbonate, potassium carbonate, potassium bicarbonate, sodium hydroxide, potassium hydroxide, disodium ethylenediaminetetraacetic acid, tetrasodium ethylenediaminetetraacetic acid or sodium pyrophosphate;
the chain transfer agent is selected from one or more of t-dodecyl mercaptan, n-dodecyl mercaptan, α-methylstyrene dimer or isooctyl 3-mercaptopropionate;
in step (1), the initiator is selected from one or more of potassium persulfate, sodium persulfate or ammonium persulfate;
in step (2), the initiator is selected from an oxidation-reduction initiator, wherein the oxidant component in the oxidation-reduction initiator is selected from one or more of potassium persulfate, sodium persulfate, ammonium persulfate, tert-butyl hydroperoxide, tert-amyl hydroperoxide or cumene hydroperoxide; and the reductant component in the oxidation-reduction initiator is selected from one or more of sodium formaldehyde sulfoxylate, sodium dithionite, ascorbic acid, erythorbic acid, sodium bisulfate, sodium metabisulfite, lactose, glucose, sorbose, fructose, maltose or ferrous sulfate.

11. The preparation method according to claim 10, wherein in step (3), the coagulant is selected from one or more of calcium chloride, magnesium sulfate, sulfuric acid or acetic acid;
the coagulant is preferably an aqueous coagulant solution with a mass percentage concentration of 2%-10%, and the addition amount of the coagulant is 4-6 wt % of the solid content in the grafted ABS latex.

12. An ABS resin, wherein the ABS resin is prepared by blending the ABS rubber powder with a low impurity content prepared by the preparation method according to claim 1 and a SAN resin, and the yellowness index of the ABS resin is less than or equal to 18.
